(19) United States
(12) Patent Application Publication
(10) Pub. No.: US 2026/0180809 A1
(43) Pub. Date: Jun. 25, 2026

(54) SYSTEM AND METHOD FOR CREDENTIAL PRESENTATION BASED ON THRESHOLD SIGNATURE

(71) Applicants: Foundation of Soongsil University-Industry Cooperation, Seoul (KR); Foundation for Research and Business, Seoul National University of Science and Technology, Seoul (KR)

(72) Inventors: Daeseon Choi, Daejeon (KR); Younho Lee, Seoul (KR)

(73) Assignees: Foundation of Soongsil University-Industry Cooperation, Seoul (KR); Foundation for Research and Business, Seoul National University of Science and Technology, Seoul (KR)

(21) Appl. No.: 19/427,156

(22) Filed: Dec. 19, 2025

(30) Foreign Application Priority Data
Dec. 19, 2024 (KR) 10-2024-0191323
Jun. 10, 2025 (KR) 10-2025-0075807

(51) Int. Cl. H04L 9/32; H04L 9/08

(52) U.S. Cl. CPC H04L 9/3247; H04L 9/0825; H04L 9/083

(57) ABSTRACT

According to an embodiment of the present disclosure, a security control system for protecting and authenticating identity information may include threshold signature parties including a user terminal configured to drive an electronic wallet, a trusted third party (TTP) server, and a backup server, and the user terminal may generate, through the electronic wallet, a private key of a user as a distributed key including a plurality of key shares according to a threshold signature technique, and store one of the generated key shares in the user terminal and transmits the other key shares to the TTP server and the backup server.

### CROSS-REFERENCE TO RELATED APPLICATION

This application claims the benefit under 35 USC 119(a) of Korean Patent Application Nos. 10-2024-0191323 filed on Dec. 19, 2024 and 10-2025-0075807 filed on Jun. 10, 2025, in the Korean Intellectual Property Office, the disclosure of which is incorporated herein by reference in its entirety.

### BACKGROUND

### Field

The present disclosure relates to a system and method for credential presentation based on a threshold signature.

### Description of Related Art

Conventional digital authentication systems have operated in a structure in which a private key of a user is stored in a single repository and a signature is generated using the private key. However, a method of storing a private key at a single point is highly vulnerable to security threats such as key leakage or device theft. In particular, in authentication systems based on a decentralized identifier (DID), although a structure is adopted in which a user submits a verifiable credential (VC) through a held electronic wallet, a third party can submit a forged verifiable credential, thereby posing a risk of identity theft of the user when the private key is leaked.

To address this, a threshold signature scheme is being considered. The threshold signature scheme is a security technique in which a single private key is divided into a plurality of key shares for storage, and a signature can be generated only when at least a certain number of key shares are combined. This makes it possible to compensate for security vulnerabilities of the single repository and to secure stronger security in that a plurality of parties are required when a signature is generated. However, in order to apply such a structure to an actual authentication system, it is necessary to solve technical challenges, such as a distributed generation, management, and recovery procedure for key shares, signature generation flow, and linkage with a relying party.

### SUMMARY

The present disclosure can provide a structure capable of preventing security threats due to leakage of a private key of a user or theft of a terminal.

The present disclosure can implement a security control system capable of safely generating keys in a distributed manner based on a threshold signature technique and generating a signature through cooperation of a plurality of signing parties.

Further, with the present disclosure, it is possible to provide an anomaly detection function capable of detecting abnormal signs based on a user's device information and performing additional authentication upon access from a new device.

The object of the present disclosure is not limited to the above, and other objects and advantages of the present disclosure that are not mentioned can be understood from the following description and will be more clearly understood by the embodiments of the present disclosure. It will also be readily appreciated that the objects and advantages of the present disclosure can be realized by means and combinations thereof shown in the claims.

According to an embodiment of the present disclosure, a security control system for protecting and authenticating identity information may include threshold signature parties including a user terminal configured to drive an electronic wallet, a trusted third party (TTP) server, and a backup server, wherein the user terminal may generate, through the electronic wallet, a private key of a user as a distributed key including a plurality of key shares according to a threshold signature technique, and store one of the generated key shares in the user terminal and transmit the other key shares to the TTP server and the backup server. Accordingly, the user terminal, the TTP server, and the backup server can hold the generated key shares.

When the user terminal intends to perform user authentication, the user terminal may combine partial signatures generated based on key shares held by the respective threshold signature parties to be equal to or greater than a threshold to generate an aggregate signature, and generate a verifiable presentation (VP) including the aggregate signature and then submit the VP to an authentication request target to request authentication.

When the TTP server intends to perform a threshold signature for user authentication, the TTP server may generate a partial signature for a threshold signature based on a key share held by the TTP server, and transmit the generated partial signature to the user terminal. The user terminal may aggregate, through the electronic wallet, the partial signature received from the TTP server and a partial signature generated by the user terminal based on a FROST (Flexible Round-Optimized Schnorr Threshold signatures) to generate an aggregate signature, and generate the VP based on the generated aggregate signature. The generated VP may be transmitted to an authentication request target (for example, a relying party (RP) server) and an authentication procedure may be performed.

The security control system may further include the RP server configured to verify authenticity of a digital signature and approve authentication, in addition to the user terminal, the TTP server, and the backup server.

The user terminal may derive a public key corresponding to the distributed key and transmits the derived public key to the RP server after the distributed key including a plurality of key shares is generated based on the threshold signature technique, and accordingly, the RP server receives and stores the public key in a blockchain or a distributed repository.

When the RP server receives an authentication request for the verifiable presentation (VP) from any service provider server as the user requests login to the service provider server, the RP server may verify validity of the aggregate signature included in the VP using a public key previously stored in the RP server, and determine whether to approve authentication according to a result of the verification.

Further, the TTP server may store the device identification information received from the user terminal generating the distributed key, and compare device information received from the user terminal with the device identification information previously registered in the TTP server each time a threshold signature is requested by the user terminal, to request additional user authentication when it is determined that a device requesting the threshold signature is different from a previously registered device.

The user terminal may request the TTP server to perform pre-verification for each verifiable credential (VC) to be included in the VP to generate the VP through the electronic wallet, and the TTP server may perform, in response to the request, pre-verification regarding an issuance structure, expiration period, and revocation for each verifiable credential.

According to an embodiment of the present disclosure, a security control system for protecting and authenticating identity information may include a user terminal configured to drive an electronic wallet, a trusted third party (TTP) server, and a backup server, wherein the user terminal may generate, through the electronic wallet, a private key of a user as a distributed key according to a Schnorr-based FROST (Flexible Round-Optimized Schnorr Threshold signatures) algorithm, store one of a plurality of key shares constituting the generated distributed key in the user terminal, and transmit the other key shares to the TTP server and the backup server.

According to an embodiment of the present disclosure, an operation method for a security control system for protecting and authenticating identity information may include the steps of: generating, by a user terminal, a private key of a user as a distributed key according to a threshold signature technique through an electronic wallet; and storing, by the user terminal, one of a plurality of key shares constituting the generated distributed key in the user terminal and transmitting the other key shares to a trusted third party (TTP) server and a backup server.

Further, according to an embodiment of the present disclosure, an operation method for a security control system for protecting and authenticating identity information may include the steps of generating, by a user terminal, a private key of a user as a distributed key according to a threshold signature technique through an electronic wallet; requesting, by the user terminal, a plurality of key shares constituting the distributed key to be stored in the user terminal, a trusted third party (TTP) server, and a backup server corresponding to respective threshold signature parties in a distributed manner; generating partial signatures based on key shares held by respective threshold signature parties to perform a threshold signature as user authentication is requested, and combining, by the user terminal, the generated partial signatures to generate an aggregate signature; and generating, by the user terminal, a verifiable presentation (VP) including the aggregate signature and submitting the generated VP to an authentication request target to request authentication.

According to the present disclosure, it is possible to eliminate security vulnerabilities of a single point and prevent damage caused by key leakage by storing distributed key shares instead of storing a private key itself.

Since a plurality of threshold signature parties cooperate to generate a signature, any signing attempt below a threshold fails, thereby preventing forgery and unauthorized signatures.

### BRIEF DESCRIPTION OF THE DRAWING

FIGS. 1A and 1B are diagrams illustrating a distributed key generation process and a public key registration process according to an embodiment of the present disclosure.

FIGS. 2A to 3B are diagrams illustrating a distributed signature procedure according to an embodiment of the present disclosure.

FIGS. 4A and 4B are diagrams illustrating a distributed signature procedure including VP verifiable credential at an issuer.

### DETAILED DESCRIPTION

The advantages and features of the present disclosure and a method of achieving these will be apparent with reference to embodiments to be described in detail below together with the accompanying drawings. However, the present disclosure is not limited to the embodiments set forth below and can be implemented in various different forms, the embodiments are provided so that the present disclosure is complete and to fully convey the scope of the invention to those skilled in the art, and the present disclosure is defined only by the scope of the claims.

The terms used in the present specification are intended to describe embodiments and not to limit the invention. In the specification, singular forms include the plural forms unless expressly stated otherwise in the context. The terms “comprises” and/or “comprising” used herein do not exclude the presence or addition of one or more other components in addition to the stated components. The same reference numerals throughout the specification denote the same components, and “and/or” includes each of the stated components and any combination of one or more thereof. Although “first,” “second,” and the like are used to describe various components, the components are not limited by these terms. The terms are used merely to distinguish one component from another. Thus, it is obvious that a first component referred to hereinafter may also be a second component within the technical spirit of the invention.

Unless otherwise defined, all terms (including technical and scientific terms) used herein may be used in a sense commonly understood by those skilled in the art to which the invention pertains. Further, terms defined in commonly used dictionaries are not ideally or excessively construed unless explicitly defined otherwise.

The terms “unit” or “module” used herein mean hardware components such as software, an FPGA, or an ASIC, and a “unit” or “module” performs certain roles. However, a “unit” or “module” is not limited to software or hardware. The “unit” or “module” may be configured to reside in an addressable storage medium and may be configured to reproduce one or more processors. Thus, as one example, the “unit” or “module” includes components such as software components, object-oriented software components, class components, and task components, and processes, functions, attributes, procedures, subroutines, segments of program code, drivers, firmware, microcode, circuits, data, databases, data structures, tables, arrays, and variables. The functions provided within the components and “units” or “modules” may be combined into a smaller number of components and “units” or “modules,” or may be further separated into additional components and “units” or “modules.”

Spatially relative terms such as “below,” “beneath,” “lower,” “above,” and “upper” may be used to easily describe a correlation between one component and other components as illustrated in the drawings. The spatially relative terms are to be understood as terms including different directions of the components when in use or operation in addition to directions shown in the drawings. For example, when a component shown in the drawings is inverted, a component described as being “below” or “beneath” another component may be placed “above” the other component. Therefore, the exemplary term “below” may include both downward and upward directions. A component can be oriented in other directions, and the spatially relative terms are construed according to the orientation.

The present disclosure relates to a distributed key-based electronic-wallet security control system that, to prevent security threats due to leakage of a private key of a user and to realize high-reliability authentication, divides the private key into a plurality of key shares, stores the key shares in a distributed manner, and performs authentication through a threshold signature scheme (for example, FROST). In the present disclosure, a threshold signature technique based on a Schnorr signature scheme is adopted so that high-reliability distributed signature is possible even when key shares held by respective parties are combined.

In the present specification, operations performed by an electronic-wallet application stored in a user terminal may be described as being performed by the electronic wallet for convenience of description.

Hereinafter, embodiments of the present disclosure will be described with reference to the accompanying drawings.

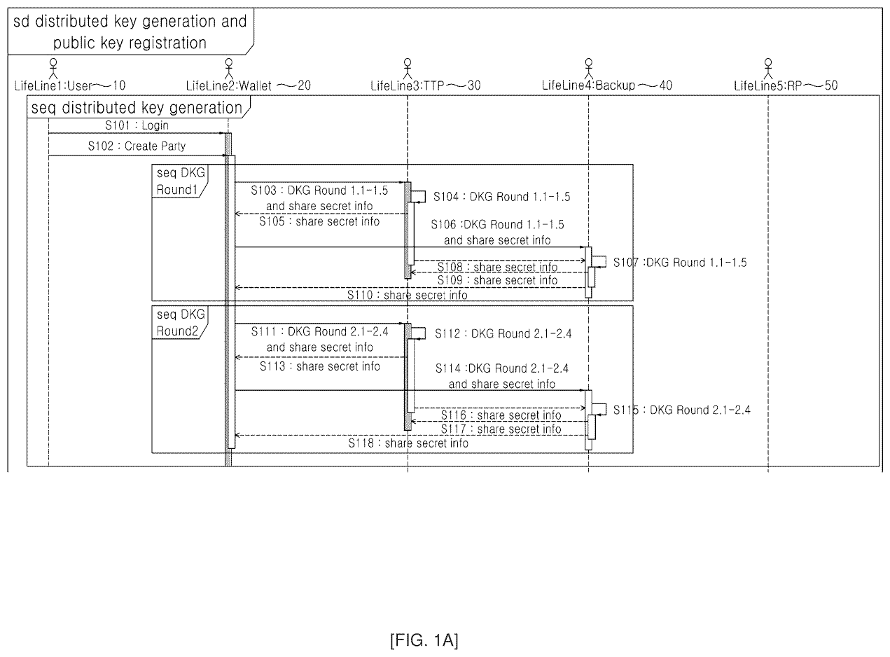

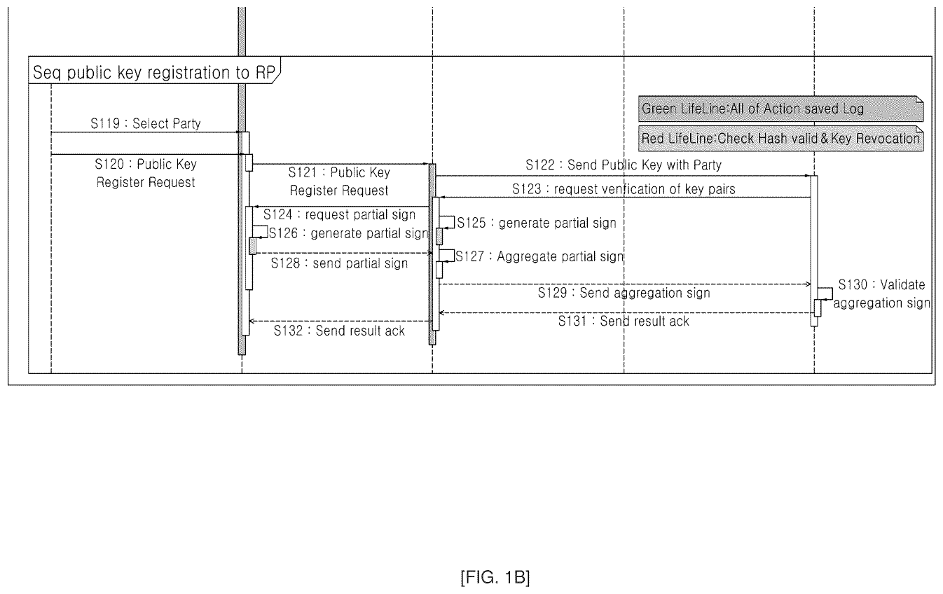

FIGS. 1A and 1B are diagrams illustrating a distributed key generation process and a public key registration process according to an embodiment of the present disclosure.

First, a distributed key generation operation will be described.

For distributed key generation, first, as illustrated in FIG. 1A, a user may request login to an electronic wallet 21 of a user terminal 20 (hereinafter, an “electronic wallet”) (S101). When the user logs in to the electronic wallet 21, the user may request creation of signing parties for key generation (S102). According to the present disclosure, the parties may include the electronic wallet 21, a trusted third party (TTP) server 30, and a backup server 40.

In response to the party generation request, parties are set, and the electronic wallet 21 can generate a distributed key that can be held respectively by the electronic wallet, the TTP server 30, and the backup server 40.

In a distributed key generation (DKG) protocol for generating the distributed key, two rounds including ROUND 1 and ROUND 2 may be performed.

A first round (Round 1) is a step of sharing secret values and transferring commitments, and a second round (Round 2) is a step of verifying the shared values.

First, the electronic wallet 21 may perform detailed operations (1.1 to 1.5) of DKG Round 1 and then share the results (shares and commitments) with the other parties (the TTP server and the backup server).

In this case, a detailed operation of DKG Round 1 corresponds to an operation in which each party creates a secret polynomial, computes a commitment and a secret share, and securely exchanges the commitments and secret shares with other parties.

In DKG Round 1, each party may generate a random secret polynomial and compute a secret share to be provided to itself and to the other parties based on the polynomial. Each party may also generate a commitment to coefficients of the polynomial and compose a message (hereinafter, “secret information”) including the commitment and the secret share. By transmitting the composed secret information to the other parties, the party may exchange the secret share with the other parties.

As illustrated in the drawings, after the electronic wallet 21 performs the detailed operation of DKG Round 1, the electronic wallet 21 may transmit results thereof (secret information including the share and the commitment) to the TTP server 30 (S103), and then the TTP server 30 may perform a DKG Round 1 process for generating its own key share based on the secret information received from the electronic wallet 21 (S104), transmit the generated secret information to the electronic wallet 21 (S105), and also transmit the generated secret information to the backup server (S108).

The electronic wallet 21 may also perform the DKG Round 1 process with the backup server 40 in the same manner and transmit the generated secret information to the backup server 40 (S106), the backup server 40 may perform the DKG Round 1 process (S107) and transmit the generated secret information to the TTP server 30 and the electronic wallet 21 (S109 and S110).

Accordingly, the key shares generated through the DKG process are stored, one each, in the electronic wallet 21 of the user terminal, the TTP server 30, and the backup server 40 so that, when these are aggregated to generate a signature, signature reconstruction is possible only when a threshold is reached.

Subsequently, each party may perform a DKG Round 2 process. DKG Round 2 corresponds to a process in which each party verifies whether the secret share received in Round 1 matches a commitment value.

Steps S111 to S118 illustrated in FIG. 1A correspond to the DKG Round 2 operation, during which all the parties can receive and verify each other's shares.

Thus, according to DKG Round 1, each party (the electronic wallet, the TTP server, and the backup server) may generate its own private key share (secret share). Such a private key share corresponds to a part constituting the entire secret key (private key). According to DKG Round 1, secret shares and commitments may be mutually transmitted among parties, and all the parties may receive the commitment values of the other parties.

Meanwhile, DKG Round 2 performs verification as to whether the share received in Round 1 matches the commitment, and leaves only the key shares that are normally valid so that a reliable key set that can be used for subsequent distributed signing can be composed. That is, as a result of DKG Round 2, all parties can finally confirm and store their own key shares and jointly compute a public key (usually derived from the commitment value) for all the parties.

Accordingly, as a result of DKG Rounds 1 and 2, the distributed private key shares and the joint public key computed therefrom can be acquired, and the generated keys can be utilized in subsequent distributed signing and VP generation.

After a distributed key generation procedure is completed, the user may select a party to be used for distributed signing and register, with a relaying party (RP) server, the public key generated based on the party. To this end, the following procedure may be performed.

The user may select a party to be used for distributed signing in the electronic wallet 21 (S119). The electronic wallet 21 internally sets information regarding a list of selected distributed signature parties. Thereafter, the user requests public key registration through the electronic wallet 21 (S120), and accordingly the electronic wallet 21 may transmit a public key registration request message to the TTP server 30 (S121). The TTP server 30 transmits to the RP server 50 data including party composition information and the public key, so that identification information of party members and the public key values can be transferred to the RP.

To verify whether the registered public key is valid, the RP server 50 may transmit a test request to the TTP server 30 to confirm whether a private key (or an aggregated distributed key) corresponding to the public key actually exists and signing is possible (S123). The TTP server 30 transfers this request to the electronic wallet 21 (S124), and accordingly the electronic wallet 21 and the TTP server 30 generate partial signatures using the key shares the electronic wallet 21 and the TTP server 30 hold (S125 and S126). The generated partial signatures are aggregated at the TTP server 30 through the FROST algorithm and generated as a single aggregate signature (S127), which is transmitted to the RP server 50 for final verification (S130).

When the aggregate signature is successfully verified, the public key is recognized as a valid distributed signature key and its registration is approved. On the other hand, when signature verification fails, public key registration may be rejected or invalidated.

The RP server 50 transmits to the TTP server 30 a message (ack) regarding a verification result, such as a message indicating that public key registration has been successfully completed (S131), and the TTP server 30 may transfer the message to the electronic wallet 21 (S132). Further, the TTP server 30 may store, in an internal log, that the user's public key registration has been completed, based on time at which the ack message is received from the relying party.

Meanwhile, the TTP server 30 may also provide a function of recording public key information registered through the user terminal 20 and then retrieving a user-specific public key history registered with the RP server 50. Through this function, the TTP server 30 may query or track and manage information such as user ID, a registration target RP, registration time, and a registered public key value, which may be utilized for audit of the registration history or for distributed signature management.

Further, for the distributed signature verification, the RP server 50 may determine the validity of a signature based on the public key information registered by the user, and the authentication may be regarded as being valid only when the public key matches a value registered in the blockchain or distributed repository.

Such a retrieval function may be implemented on a management interface (UI) of the TTP server or on an internal recording system.

During a distributed key generation and public key registration process, each party records, as a log, the operations performed and messages exchanged in DKG Rounds 1 and 2 to ensure the legitimacy of key generation and integrity during subsequent signature verification. Such log recording operations are illustrated by portions indicated in green in FIGS. 1A and 1B.

For reference, items indicated in pink in FIG. 1B shows that each party generating the partial signature (the TTP server and the electronic wallet) performs an operation of checking hash validity and key revocation on the generated partial signature after an operation of generating a partial signature (S225 and S226).

In this case, an operation of checking the hash validity is a procedure of verifying whether the signature has been generated from normal input (key share, message, or the like), and may correspond to an operation of checking, for example, whether the partial signature is forged, the integrity of a FROST-or Schnorr-based signature, and whether a hash matches a previous log.

Further, according to an embodiment of the present disclosure, the TTP server 30 may provide a function of retrieving login records.

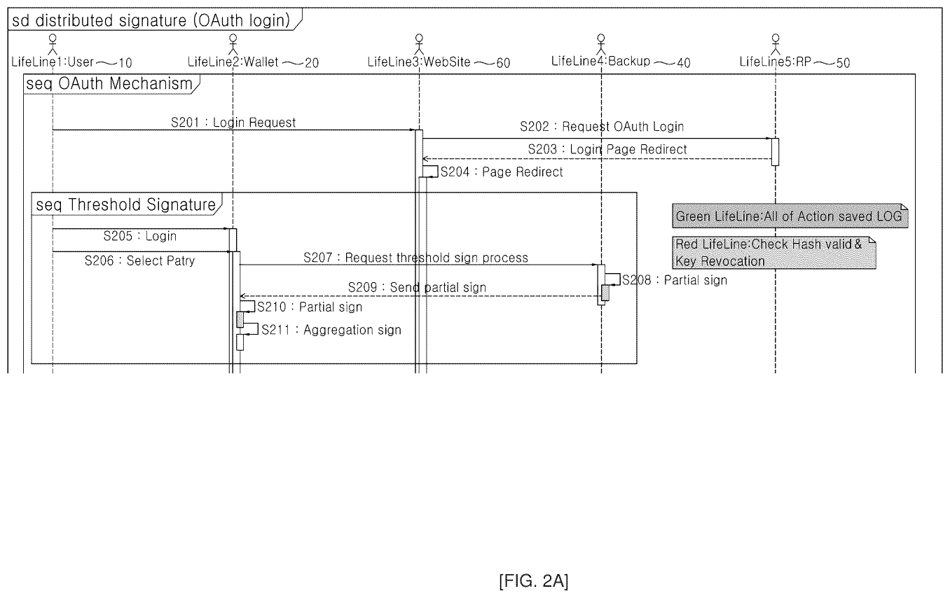

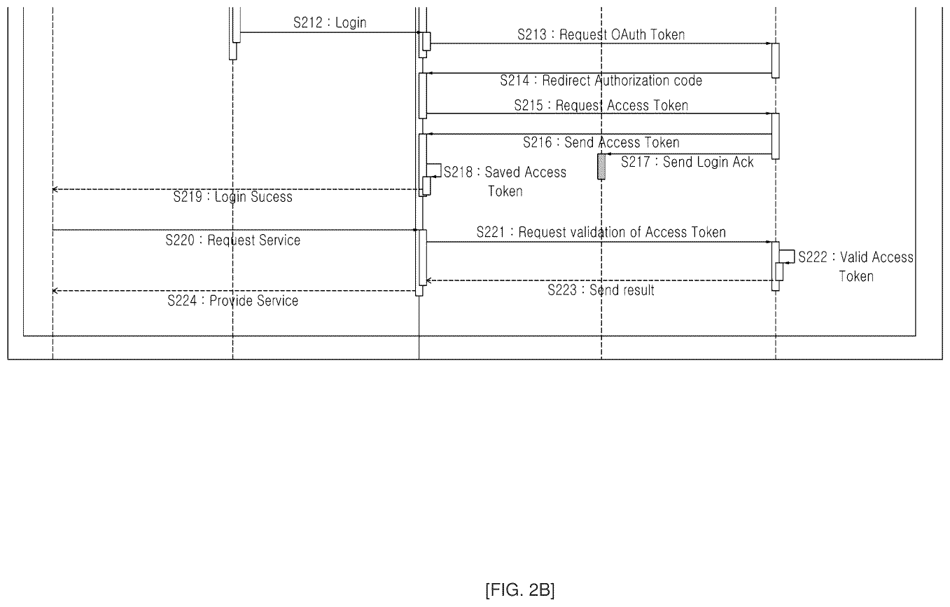

FIGS. 2A and 2B are diagrams illustrating a distributed signature procedure according to an embodiment of the present disclosure.

As illustrated in FIGS. 2A and 2B, according to the present disclosure, it is possible to perform a distributed signature operation for open authorization (OAuth) login. Specifically, FIGS. 2A and 2B illustrate a distributed signature (threshold signature) process in which the user attempts the OAuth login (an authentication scheme that allows the user to safely log in to another website or application using an account already authenticated by a third-party service, without separate sign-up or password entry; for example, social login) in order to log in to a service provider (an entity that provides certain services based on login, such as a website). In FIGS. 2A and 2B, the service provider corresponds to a website, and accordingly, the website or website server is set as the operating entity in the description below.

The user may request login to any website corresponding to the service provider using an OAuth login scheme (S201), and accordingly, the website may request the RP server 50 (an institution that provides services in an OAuth scheme and performs verification of authentication information) to process an OAuth login for a user 10 (S202). Accordingly, the RP server 50 may redirect an OAuth login page to the website so that the user can check the login page (203).

Thereafter, to perform login on the confirmed OAuth login page, the user attempts an identity authentication process through the electronic wallet 21 of the user terminal 20, and in this case, a threshold signature (or distributed signature) process according to an embodiment of the present disclosure may be performed.

Specifically, a threshold signature process according to an embodiment of the present disclosure may include steps S205 to S211 below.

For reference, the distributed signature (threshold signature) may also be termed a threshold signature, and in the present specification, “distributed signature” and “threshold signature” are used interchangeably.

The threshold signature is a term that is used based on the fact that a signature is possible when the distributed key shares are combined at or above a threshold, and for example, among n parties each having a key share, a signature is possible when at least t parties gather.

Meanwhile, the distributed signature is used in such a manner that the entire signature is not generated with a single private key, but several entities each use its own key share to create a partial signature, and the partial signatures are aggregated and combined into a final signature.

The threshold signature process according to an embodiment of the present disclosure corresponds to an operation of combining a plurality of partial signatures at or above a threshold to generate an aggregate signature, and will be described below.

First, the user 10 may attempt to log in to the electronic wallet 21 of the user terminal 20 (S205). The electronic wallet involves user authentication because electronic wallet handles a personal domain such as private keys and a verifiable credential (VC; for example, a credential itself issued by an official issuing authority such as a driver's license and a graduation certificate). Step S205 may be an operation of checking the user's identity by authenticating the electronic wallet 21, and in this case, for example, biometric authentication or PIN authentication may be performed to log in to the electronic wallet 21. The user may perform step S206 of selecting threshold signature parties (key share holders) in the electronic wallet 21 of the user terminal 20 (hereinafter, an “electronic wallet”). As described above, in the present disclosure, the threshold signature parties holding the key shares correspond to the user terminal (electronic wallet) 20, the TTP server 30, and the backup server 40.

Subsequently, the electronic wallet 21 of the user terminal 20 may perform step S207 of requesting the TTP server 30 to perform a distributed signature (threshold signature), and accordingly the TTP server 30 may perform step S208 of generating a partial signature using its own key share.

Since the distributed signature is performed in this manner, the TTP server 30 may generate a partial signature for the user's login request message using the piece of the private key held by the TTP server 30 (S208) and perform step S209 of transferring the result (the partial signature) to the electronic wallet 21 of the user terminal 20. Thereafter, the electronic wallet 21 may store the partial signature received from the TTP server 30, generates its own partial signature (S210), and generate an aggregate signature according to an operation of collecting and combining several partial signatures into a single signature (S211).

Thus, when the user logs in to the electronic wallet 21 using the distributed signature as in steps S205 to S211, the system according to an embodiment of the present disclosure may perform step of transferring, by the electronic wallet 21, a login request signal including the aggregate signature to a website 60 (S212). In other words, the electronic wallet 21 creates the aggregate signature for OAuth login authentication and submits the aggregate signature to the service provider.

After S212, the website 60 (for example, a website management server) transmits a login request to the RP server 50 and request an OAuth token (S213). In this case, information including the signature may also be transferred. This is because, in the OAuth structure, the RP is a final authentication and token issuing entity, and therefore, a login result and signature should be passed to the RP.

After S213, the RP server 50 may verify the signature and transfer an authorization code indicating successful login to the website 60 (S214). The website 60 then sends the received authorization code back to the RP server 50 to request an access token (S215). Accordingly, the RP server 50 may issue the access token and transfer the access token to the website 60 (S216). By holding the access token, the website 60 may access the user's resources. Accordingly, the website may recognize the user as authenticated and prepare to provide services.

Further, the RP server 50 transfers a login verification result (success or failure) to the TTP server 30 so that the TTP server 30 records a verification record (S217).

As described above, as the TTP server 30 receives the login verification result, the TTP server 30 may record, in an internal repository or log, a login authentication record including the user's login time, the verification result (success or failure), RP identification information, and the like (indicated in green in the drawing).

Further, the TTP server 30 may provide a function of retrieving details specific to a user who logs in to the RP based on such a stored login record.

For example, an administrator may view a login history based on a specific user ID or check an all-user login history for a specific RP, and this may be implemented through a TTP management screen or an internal interface.

Such a login history retrieval function may be used for purposes such as security audit, account access monitoring, and abnormal use detection.

The website 60 may store the access token received from the RP server 50 (S218) and provide result information regarding successful login to the user (S219).

As the user requests an actual service through the electronic wallet 21 after login is completed (S220), the website 60 may request the RP server 50 to verify the validity of the access token (S221).

Thereafter, the RP server 50 may check the validity of the access token (S222). Subsequently, the RP server 50 may transmit a result of checking the validity of the access token to the website 60 (S223), and the website 60 may provide the service requested by the user to the user when the validity of the access token is confirmed (S224).

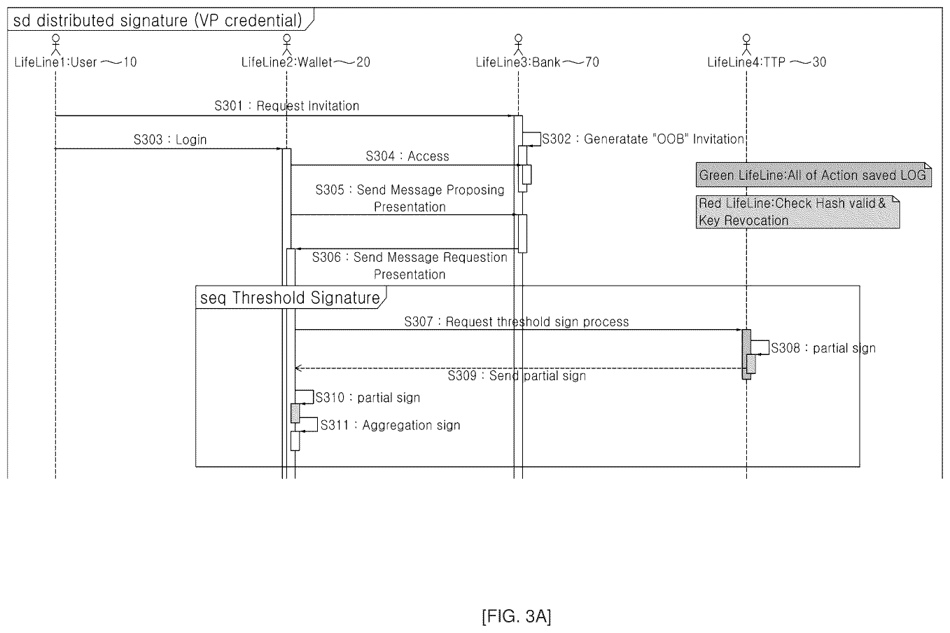

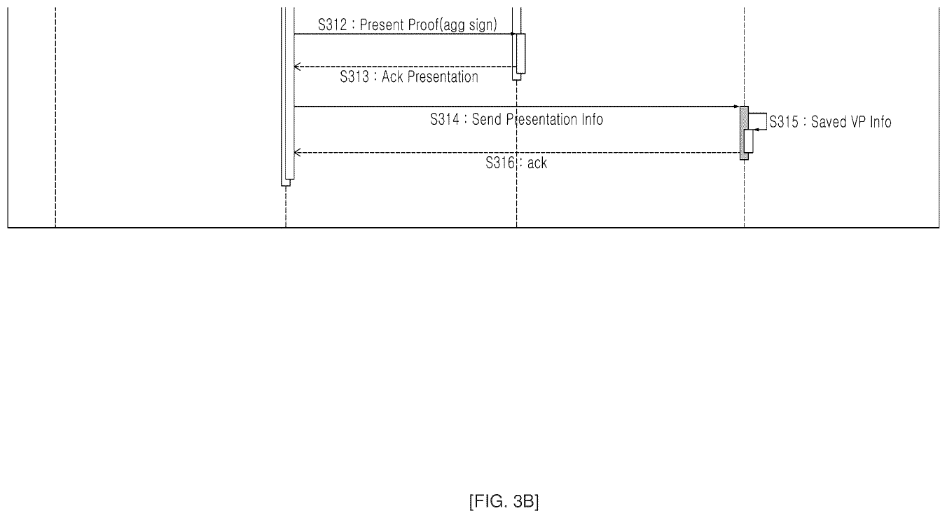

Hereinafter, an operation of managing VP submission in the TTP server will be described with reference to FIGS. 3A and 3B.

FIGS. 3A and 3B illustrate a procedure of distributed signature including VP credential.

As illustrated, the user may request an invitation from a bank server 70 that is one of the service providers in order to use a service (for example, identity verification or certificate submission) (S301). In response to the user's request, the bank server 70 may generate an out-of-band (OOB) invitation (S302). For reference, the OOB means handling something outside a main communication channel, and the OOB invitation is data for transferring connection information via through an external channel (for example, QR code, e-mail, or link) to initiate a DID connection with a counterparty. That is, S302 may be starting a separate channel or a message-based authentication flow for submission of a VP (a format in which the user presents the user's verifiable credential (VC)).

The user logs in to the electronic wallet 21 of the user terminal 20 (S302), and the electronic wallet 21 may request connection to the bank server 70 (S304). Also, the electronic wallet 21 may transmit to the bank server 70 a proposal message indicating an intention to submit a VP (S305).

Accordingly, the bank server 70 may transmit to the electronic wallet 21 a submission request message having the meaning “please send a certain verifiable presentation (VP)” (S306). This corresponds to an operation in which the bank server 70 specifies concrete submission items to the electronic wallet 21.

When the electronic wallet 21 receives information on the submission items according to S306, the electronic wallet 21 may, correspondingly, send a request for a partial signature to the TTP server 30 to perform a threshold signature for VP submission (S307).

Subsequently, the TTP server 30 may generate a partial signature using its own key share (this signature share cannot be used to a generate a signature on its own and a final signature can be generated only through combination) (S308). In addition to generating the partial signature, the TTP server 30 may perform an operation of storing, as a log, a process until the signature is generated. In FIG. 3A, operations related to generating the partial signature are indicated in green, thereby indicating that the process is recorded as a log. Further, in FIG. 3A, operations after S308 are indicated in pink, indicating that the operation of checking hash validity and key revocation is performed on the generated partial signature.

In this case, an operation of checking the hash validity is a procedure of verifying whether the signature has been generated from normal input (key share, message, or the like), and may correspond to an operation of checking, for example, whether the partial signature is forged, the integrity of a FROST-or Schnorr-based signature, and whether a hash matches a previous log.

An operation of checking key revocation status means an operation of checking whether the key share used for signing has been revoked or expired. For example, when the TTP server 30 revokes a user's key, a situation may occur in which a partial signature generated with the key is invalid. Accordingly, the operation of checking key revocation status becomes necessary.

When the validity is confirmed by checking the operation of checking hash validity and key revocation for the partial signature generated as described above, the TTP server 30 may transmit the generated partial signature to the electronic wallet 21 of the user terminal 20 (S309).

Thereafter, the electronic wallet 21 also generates a partial signature using the key share already held by the electronic wallet 21 (S310) and, in this case, the validity of the generated partial signature may be confirmed through the operation of checking hash validity and key revocation.

When the validity is confirmed, the electronic wallet 21 may combine the partial signature generated by the electronic wallet 21 with the partial signature received from the TTP server 30 in a FROST-based manner to generate an aggregate signature (S311).

Next, the electronic wallet 21 may transmit to the bank server 70 a verifiable presentation (VP) including the aggregate signature generated through the distributed signing (S312). In this case, the aggregate signature is included in a proof field of the VP, and a verifier can verify the user's identity through the proof field. In particular, according to the present disclosure, the electronic wallet 21 may implement privacy protection and an identity-verification function by encrypting the user's identification information (for example, gid) using the aggregated threshold signature and including the identification information in the VP.

Accordingly, when an acknowledgment (Ack) message is received from the bank server 70 (S313), the electronic wallet 21 may transmit, to the TTP server 30, presentation information indicating that the electronic wallet 21 has previously submitted the VP to the bank server (S314). The TTP server 30 may then store the VP submission content (VP info) of the electronic wallet 21 in the log, and the recorded content may include fact of participation in the signature, the user's VP submission content, and the like.

Finally, the TTP server 30 may transmit a final acknowledgment (Ack) for completion of log storage or confirmation of reception to the electronic wallet 21 (S316).

As described with reference to FIGS. 3A and 3B, with the present disclosure, it is possible to provide a threshold signature-based distributed authentication procedure in which a private key of a user is divided into a plurality of key shares and stored in the electronic wallet and the TTP in a distributed manner, the electronic wallet and the TTP generate partial signatures when the user submits the verifiable credential (VP), and the electronic wallet causes a signature generated by aggregating these to be included in the proof field of the VP. In this case, in addition to the aggregate signature, the proof field of the VP may further include metadata information indicating that signature generation has been performed in a distributed signature manner (FROST). Further, the TTP is configured to store a submission log including a target to which the VP has been submitted, the time, user identification information, and the like, together with a history of partial-signature generation so that such information can be retrieved later, thereby realizing reliability of a verifiable credential submission process, traceability, and a security-audit function.

Further, in the present disclosure, an operation of preventing fraudulent use from a stolen electronic wallet may be performed. In the conventional case, when an electronic wallet was stolen, technical measures to prevent the risk that a revoked key would be used or that fraudulent transactions would occur were insufficient. To address this problem, in the present disclosure, when the revoked key is used, the TTP can detect this and perform a warning operation to prevent fraudulent transactions in advance. Further, by strengthening validation of VC, fraudulent use through a stolen wallet can be prevented.

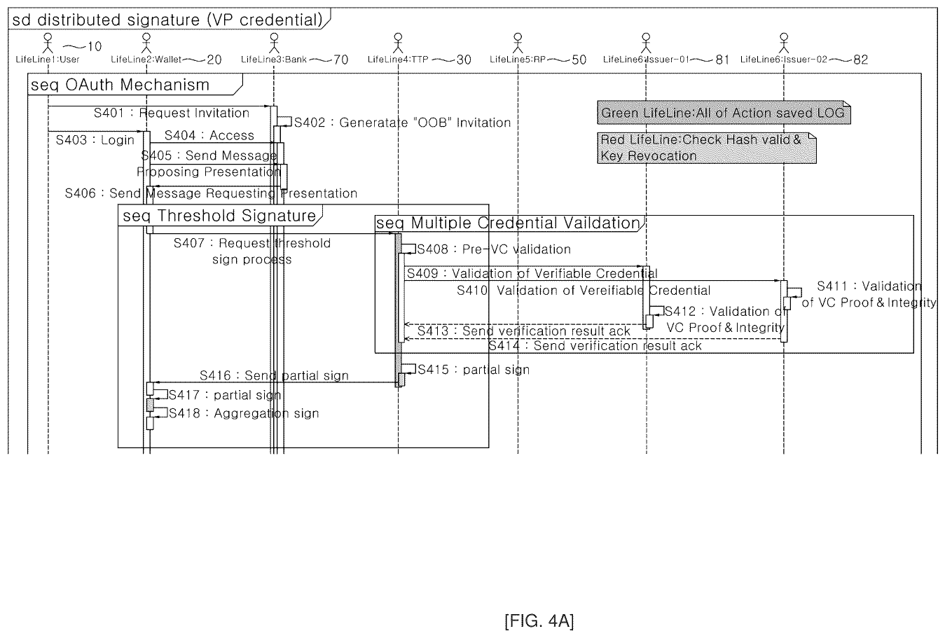

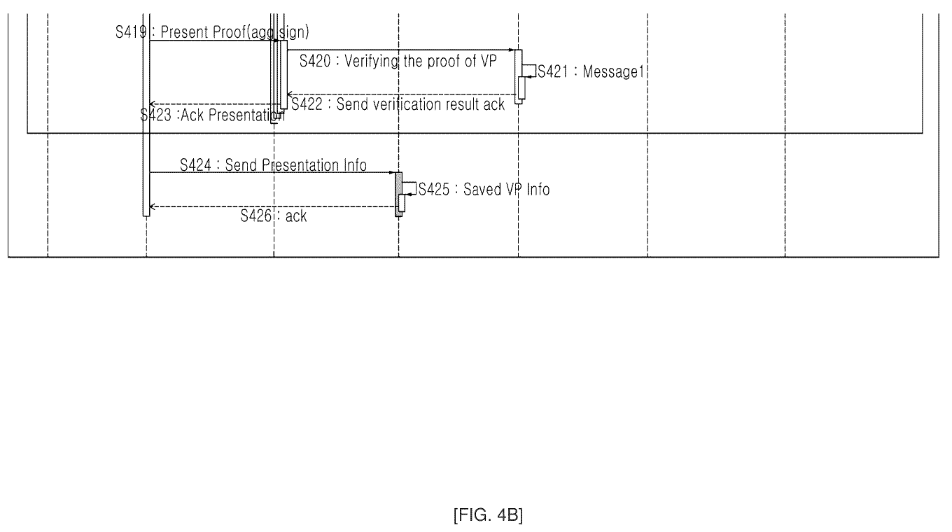

A more detailed description thereof will be given with reference to FIGS. 4A and 4B.

FIGS. 4A and 4B illustrate a distributed signature procedure for VP verifiable credential including issuer verification.

First, the user may transmit to the bank server 70 a request signal for service access (S401), and accordingly the bank server 70 may generate the OOB invitation (S402).

The user transmits a login request for the electronic wallet 21 (S403). Accordingly, the electronic wallet 21 may respond to the invitation to the bank server 70 (S404) and may transmit an intention to submit a VP (S405). Accordingly, the bank server 70 may transmit to the electronic wallet 21 a message for specifying which VP is required (S406).

Accordingly, the electronic wallet 21 may perform threshold signature operation steps. Specifically, the electronic wallet 21 may first transmit a signal for requesting a threshold signature procedure to the TTP server 30 (S407). Thereafter, before the TTP server 30 sends, to an issuer, a direct request for the verifiable credential (VC) included in the VP that the user intends to submit, the TTP server 30 may perform a basic pre-validation regarding structural validity, expiration, revocation, and the like of the VC (S408).

When the basic pre-validation is passed, the TTP server 30 may transmit the VC to an issuing institution that has issued the verifiable credential to obtain an official verification result regarding the authenticity of the VC. First, the TTP server 30 may request verification of the VC to a first issuer 81 (S409), and may also request the verification of the VC to a second issuer 82 (S410). Accordingly, the first issuer 81 and the second issuer 82 may r perform operations (S412 and S411) of verifying whether the signature of the VC submitted by the user is correct (proof verification) and whether the content of the VC have not been tampered with and remain original (integrity verification), respectively. Acknowledgments (Acks) regarding verification results may be transmitted from the first issuer 81 and the second issuer 82 to the TTP server 30 (S413 and S414).

As such, the TTP server 30 of the present disclosure can request a plurality of issuers to perform VC verification. This corresponds to an operation in which, since the VCs included in the VP may be issued by several issuers, the TTP server 30 confirms the authenticity and status from the respective issuer for each VC.

When the verification of the VC in each issuer is completed as described above, the TTP 30 may generate a partial signature based on the key share held by the TTP (S415). For reference, in this case, the TTP server 30 may record a log for the verification procedure for each VC and the operation of generating the partial signature performed by the TTP, and the validity of the partial signature generated by the TTP may be confirmed based on checking hash validity and key revocation. When the partial signature is generated at the TTP server 30 and transmitted to the electronic wallet 21 of the user terminal (S416), the electronic wallet 21 may generate a partial signature based on its own key share (S417) and combine this partial signature with the partial signature received from the TTP to generate an aggregate signature (S418).

When the aggregate signature is generated as described above, the electronic wallet 21 may transmit the VP including the aggregate signature to the bank server 70 (S419).

After receiving the VP, the bank server 70 may request the RP server 50 to perform the verification of the validity of the aggregate signature included in the VP, structural verification of the content of the verifiable credential included in the VP itself, and the like (S420).

When such verification is completed, the bank server 70 may generate a message regarding a verification result (S421) and transmit a message (Ack) regarding the verification result to the bank server 70 (S422). In response, the electronic wallet 21 may transmit a reception response signal to the bank server 70 in response to the received acknowledgment message (S422).

Thereafter, the bank server 70 may transmit a final acceptance message (Ack) for re-checking that VP submission has been normally completed to the electronic wallet 21 (S423).

The electronic wallet 21 may transmit to the TTP server 30 information on which the credential has been submitted for the VP submitted by the user and where (for example, which bank) the credential has been submitted (S424). Accordingly, the TTP server 30 may record the submission history received from the electronic wallet 21 on a log repository (S425) and transmit information (ack) indicating that the operation S425 has been completed to the electronic wallet 21 (S426).

As described with reference to FIGS. 4A and 4B, in the present disclosure, the TTP server 30 is configured to check whether the key share used for each signature has been revoked and ensure the validity of the signature in generating the partial signature. Further, when a VP submission request is made by the electronic wallet 21, the TTP server 30 may perform pre-validation regarding structural validity, expiration, and revocation for each VC included in the VP and then, transmit the VC to the issuing institution for each verifiable credential to perform official verification for the integrity (proof) and authenticity of the signature included in the VC.

According to the present disclosure, such a process makes it possible to accurately ascertain information such as attributes, expiration period, and revocation status of each VC even when a plurality of VCs issued by a large number of issuers are included, and to ensure traceability and auditability of an overall submission and verification procedure by the TTP server 30 receiving the submission information and recording the submission information on an internal log when VP submission is finally completed.

Further, the present disclosure has various differences from the related art, in addition to the foregoing.

First, with the present disclosure, it is possible to provide a function of identifying and tracking behaviors of a wallet owner and a user through clustering-based analysis, and thereby detecting whether a key is being fraudulently used in advance.

In the related art, even when the verifiable credential (VC) is fraudulently used, it is often difficult to clearly identify who owns the VC, and a problem is often recognized only after the key has already been fraudulent. However, according to the present disclosure, by collecting identification information (such as a device ID) of a client terminal at the time of distributed key generation and storing the identification information in the TTP server, it is possible to compare the identification information with terminal information and perform verification upon a subsequent distributed signature or authentication request.

More specifically, according to the present disclosure, when a distributed key is initially generated (S101 to S118, see FIG. 1A), device identification information (for example, a device ID) of the user's terminal may be transferred to and stored in the TTP. Thereafter, when the user requests a distributed signature through the electronic wallet (for example, S207), the TTP server 30 may determine whether terminal information (such as a device ID) included in the request matches previously registered device identification information.

In this case, when the terminal information included in the request is different from initially registered device identification information, the TTP server 30 may detect a possibility of fraudulent use and requests the user to perform additional authentication (for example, ID/PW input). According to the present disclosure, such re-authentication makes it possible to prevent abnormal access attempts that may occur in a new environment or on a new device, and to block fraudulent use prior to a stage at which a key is revoked.

Further, according to an embodiment of the present disclosure, the TTP server 30 may perform clustering analysis based on the user's terminal information and learn usage patterns of the terminal to strengthen an anomaly detection function.

This makes it possible to take security enhancement measures, such as adjusting a risk-based authentication level or separately storing logs, for requests that are made from a different region, time zone, or device than usual although such a behavior is from the same user,.

The above function operates in association with the flow of FIG. 1 and, in particular, confirmation of terminal information, detection of fraudulent use, a re-authentication request, and the like may be automatically performed by the TTP server 30 at a time point of a distributed signature request (see FIG. 1B).

Further, with the present disclosure, it is possible to provide a function of blocking the use of a forged or tampered VC in advance and protecting user privacy.

In a conventional DID-based authentication system, there was a lack of a function of pre-verifying whether a VC submitted by a user has been forged or tampered with and blocking this and thus a forged verifiable credential may be used in an authentication process, causing a problem that the user's sensitive information is exposed.

To solve such a problem, in the present disclosure, a procedure of performing a pre-VC validation process on VCs that are submission targets is introduced before a user submits the verifiable presentation (VP).

Specifically, in an integrated identity multi-domain environment (for example, a situation in which VCs issued in a plurality of service domains are presented in an integrated manner), when a user performs a VP proposal, the validity and forgery or tampering of the domains may be pre-verified for the plurality of VCs included in the proposal according to the present disclosure.

For example, assuming that the user selects two VCs for the VP proposal, the system may check an issuer (DID), an issuance time, a signature value, cryptographic integrity, and the like for each VC, and immediately stop a process when the VC has been forged or tampered with or when domains do not match.

Accordingly, as illustrated in FIGS. 4A and 4B, with the system of the present disclosure, it is possible to detect an attempt of authentication using the VC forged or tampered at a VP generation and submission stage or a combination of VCs of different domains, and thus to achieve both prevention of fraudulent use and privacy protection.

Further, in an embodiment of the present disclosure, it is possible to automatically perform a security response procedure such as issuing a warning message, blocking a request, or requiring separate authentication for a specific VC or VP combination based on a result of a pre-verification process.

Further, with the present disclosure, it is possible to improve security limitations of the related art by providing a function of verifying integrity of a private key (or a key share) stored in the electronic wallet.

According to an embodiment of the present disclosure, when the electronic wallet stores the private key or the key share, the electronic wallet generates and stores a hash of a relevant value together, and then, before performing a signing operation (for example, generating the partial signature), the electronic wallet can verify integrity by comparing a stored hash with a current hash value of the key share.

In particular, as illustrated in FIGS. 3A and 3B, in step S310 in which the user generates the partial signature in the electronic wallet to perform a distributed signature, the electronic wallet may verify a hash value of the key share in the repository in advance and determine whether tampering has occurred.

According to the present disclosure, when the hash verification fails, it is possible to output to the user an alert on the user terminal 20 on which the electronic wallet 21 is driven, or perform a security operation of blocking generation of the partial signature, thereby preventing an incorrect signature from being leaked to the outside.

Further, the same hash verification procedure may be applied not only to the electronic wallet but also to the partial signature generated at the TTP server 30 (S308). Accordingly, all signing entities may pre-verify the integrity of its own key share, and may refuse a signature request or notify an administrator of problem when the problem is detected.

In short, a security control system for protecting and authenticating identity information according to an embodiment of the present disclosure may include threshold signature parties including a user terminal configured to drive an electronic wallet, a TTP server, and a backup server, wherein the user terminal may generate, through the electronic wallet, a private key of a user as a distributed key including a plurality of key shares according to a threshold signature technique, and store one of the generated key shares in the user terminal and transmit the other key shares to the TTP server and the backup server. Accordingly, the user terminal, the TTP server, and the backup server may hold the generated key shares.

When the user terminal intends to perform user authentication, the user terminal may combine partial signatures generated based on key shares held by the respective threshold signature parties to be equal to or greater than a threshold to generate an aggregate signature, and generate a verifiable presentation (VP) including the aggregate signature and then submit the VP to an authentication request target to request authentication.

When the TTP server intends to perform a threshold signature for user authentication, the TTP server may generate a partial signature for a threshold signature based on a key share held by the TTP server, and transmit the generated partial signature to the user terminal. The user terminal may aggregate, through the electronic wallet, the partial signature received from the TTP server and a partial signature generated by the user terminal based on a FROST (Flexible Round-Optimized Schnorr Threshold signatures) to generate an aggregate signature, and generate the VP based on the generated aggregate signature. The generated VP may be transmitted to an authentication request target (for example, an RP server) and an authentication procedure may be performed.

The security control system may further include an RP server configured to verify authenticity of a digital signature and approve authentication, in addition to the user terminal, the TTP server, and the backup server.

The user terminal may derive a public key corresponding to the distributed key and transmits the derived public key to the RP server after the distributed key including a plurality of key shares is generated based on the threshold signature technique, and accordingly, the RP server receives and stores the public key.

When the RP server receives an authentication request for the verifiable presentation (VP) from any service provider server as the user requests login to the service provider server, the RP server may verify validity of the aggregate signature included in the VP using a public key previously stored in the RP server, and determine whether to approve authentication according to a result of the verification.

Further, the TTP server may store the device identification information received from the user terminal generating the distributed key, and compare device information received from the user terminal with the device identification information previously registered in the TTP server each time a threshold signature is requested by the user terminal, to request additional user authentication when it is determined that a device requesting the threshold signature is different from a previously registered device.

The user terminal may request the TTP server to perform pre-verification for each verifiable credential (VC) to be included in the VP to generate the VP through the electronic wallet, and the TTP server may perform, in response to the request, pre-verification regarding an issuance structure, expiration period, and revocation for each verifiable credential.

A security control system for protecting and authenticating identity information according to an embodiment of the present disclosure may include a user terminal configured to drive an electronic wallet, a trusted third party (TTP) server, and a backup server, wherein the user terminal may generate, through the electronic wallet, a private key of a user as a distributed key according to a Schnorr-based FROST (Flexible Round-Optimized Schnorr Threshold signatures) algorithm, store one of a plurality of key shares constituting the generated distributed key in the user terminal, and transmit the other key shares to the TTP server and the backup server.

An operation method for a security control system for protecting and authenticating identity information according to an embodiment of the present disclosure may include the steps of: generating, by a user terminal, a private key of a user as a distributed key according to a threshold signature technique through an electronic wallet; and storing, by the user terminal, one of a plurality of key shares constituting the generated distributed key in the user terminal and transmitting the other key shares to a trusted third party (TTP) server and a backup server.

Further, an operation method for a security control system for protecting and authenticating identity information according to an embodiment of the present disclosure may include the steps of generating, by a user terminal, a private key of a user as a distributed key according to a threshold signature technique through an electronic wallet; requesting, by the user terminal, a plurality of key shares constituting the distributed key to be stored in the user terminal, a trusted third party (TTP) server, and a backup server corresponding to respective threshold signature parties in a distributed manner; generating partial signatures based on key shares held by respective threshold signature parties to perform a threshold signature as user authentication is requested, and combining, by the user terminal, the generated partial signatures to generate an aggregate signature; and generating, by the user terminal, a verifiable presentation (VP) including the aggregate signature and submitting the generated VP to an authentication request target to request authentication.

The user terminal and server according to an embodiment of the present disclosure may include, for example, a processor, a memory, and a communication unit.

The memory may store various programs and data necessary for operation of an electronic device. The memory may be implemented as, for example, a non-volatile memory, a volatile memory, a flash memory, a hard disk drive (HDD), or a solid-state drive (SSD).

The communication unit may perform communication with an external device. In particular, the communication unit may include various communication chips such as a Wi-Fi chip, a Bluetooth chip, a wireless communication chip, an NFC chip, and a low-power Bluetooth (BLE) chip. In this case, the Wi-Fi chip, the Bluetooth chip, and the NFC chip perform communication according to a LAN, Wi-Fi, Bluetooth, and NFC scheme, respectively. When the Wi-Fi chip or the Bluetooth chip is used, various connection information such as an SSID and a session key may be first transmitted or received, communication may be connected using the same, and then, various types of information may be transmitted/received. The wireless-communication chip refers to a chip that performs communication according to various communication standards, such as IEEE, ZigBee, third generation (3G), third generation partnership project (3GPP), and long term evolution (LTE).

The processor may control an overall operation of a user device by using various programs stored in the memory. The processor may include a RAM, a ROM, a graphics processing unit, a main CPU, first to n-th interfaces, and a bus. In this case, the RAM, the ROM, the graphics processing unit, the main CPU, and the first to n-th interfaces may be connected to each other through the bus.

The RAM stores an O/S and application programs. Specifically, when an electronic device is booted, the O/S is stored in the RAM, and various types of application data selected by a user may be stored in the RAM.

A command set for system booting, for example, is stored in the ROM. When a turn-on command is input and power is supplied, a main CPU copies the O/S stored in the memory (200) to the RAM and executes the O/S to boot the system according to an instruction stored in the ROM. Upon completion of booting, the main CPU copies various application programs stored in the memory to the RAM and executes the application programs copied to the RAM to perform various operations.

The main CPU accesses the memory and performs operations including booting and execution using the O/S stored in the memory. Further, the main CPU performs various operations by using, for example, various programs, content, and data stored in the memory.

The first to n-th interfaces are connected to the various components described above. One of the first to n-th interfaces may be a network interface that is connected with an external device through a network.

Further, the processor may control an artificial intelligence model. In this case, a control unit may include a graphics-dedicated processor (for example, a GPU) for controlling the artificial intelligence model.

The processor may include one or more cores (not shown), a graphics processing unit (not shown), and a connection path (for example, a bus) for transmitting or receiving signals to or from other components.

The processor according to one embodiment executes one or more instructions stored in the memory to perform the methods described in connection with the present disclosure.

Meanwhile, the processor may further include a random access memory (RAM; not shown) and a read only memory (ROM; not shown) that temporarily and/or permanently stores signals (or data) processed inside the processor. Further, the processor 130 may be implemented in a system-on-chip (SoC) form including at least one of a graphics processing unit, the RAM, and the ROM.

Programs (one or more instructions) for processing and control of the processor may be stored in the memory. Programs stored in a storage unit may be divided into a plurality of modules according to functions.

Steps of the methods or algorithms described in connection with the embodiments of the present disclosure may be directly implemented in hardware, implemented as software modules executed by hardware, or implemented by a combination thereof. The software modules may reside in a random access memory (RAM), a read only memory (ROM), an erasable programmable ROM (EPROM), an electrically erasable programmable ROM (EEPROM), a flash memory, a hard disk, a removable disc, a CD-ROM, or any form of computer-readable recording medium well known in the art to which the present disclosure pertains.

The components of the present disclosure may be implemented as a program (or application) to be executed in conjunction with computer hardware and may be stored in a medium. The components of the present disclosure may be executed as software programming or software elements and, similarly, the embodiments may be implemented in a programming or scripting language such as C, C++, Java, and assembler, including various algorithms implemented as a combination of data structures, processes, routines, or other programming configurations. Functional aspects may be implemented as an algorithm executed by one or more processors.

Although the present disclosure has been described in detail with reference to the above-described examples, those skilled in the art may make modifications, changes, and variations to the examples without departing from the scope of the present disclosure. In short, in order to achieve intended effects of the present disclosure, it is not necessary to separately include all functional blocks illustrated in the drawings or to follow all sequences illustrated in the drawings as illustrated, and it should be noted that even otherwise, such cases may sufficiently fall within the technical scope of the present disclosure as recited in the claims.

### DESCRIPTION OF REFERENCE NUMERALS

20: User terminal
21: Electronic wallet
30: TTP server
40: Backup server
50: RP server

What is claimed is:

1. A security control system for protecting and authenticating identity information, the security control system comprising threshold signature parties including a user terminal configured to drive an electronic wallet, a trusted third party (TTP) server, and a backup server,
wherein the user terminal
generates, through the electronic wallet, a private key of a user as a distributed key including a plurality of key shares according to a threshold signature technique, and
stores one of the generated key shares in the user terminal and transmits the other key shares to the TTP server and the backup server.

2. The security control system of claim 1, wherein the user terminal
combines partial signatures generated based on key shares held by the respective threshold signature parties to be equal to or greater than a threshold to generate an aggregate signature as user authentication is requested, and
generates a verifiable presentation (VP) including the aggregate signature and then submits the VP to an authentication request target to request authentication.

3. The security control system of claim 2,
wherein the TTP server generates a partial signature for a threshold signature based on a key share held by the TTP server as a threshold signature is requested, and transmits the generated partial signature to the user terminal, and
the user terminal aggregates, through the electronic wallet, the partial signature received from the TTP server and a partial signature generated by the user terminal based on a FROST (Flexible Round-Optimized Schnorr Threshold signatures) to generate an aggregate signature, and generates the VP based on the generated aggregate signature.

4. The security control system of claim 3,
wherein the security control system further includes a relaying party (RP) server configured to verify authenticity of a digital signature and approve authentication,
the user terminal derives a public key corresponding to the distributed key and transmits the derived public key to the RP server after the distributed key including a plurality of key shares is generated based on the threshold signature technique, and
the RP server receives and stores the public key.

5. The security control system of claim 4, wherein, when the RP server receives an authentication request for the VP from any service provider server as a user requests login to the service provider server, the RP server verifies validity of the aggregate signature included in the VP using a public key previously stored in the RP server, and determines whether to approve authentication according to a result of the verification.

6. The security control system of claim 2, wherein the TTP server
stores device identification information received from a user terminal generating the distributed key, and
compares device information received from the user terminal with the device identification information previously registered in the TTP server each time a threshold signature is requested by the user terminal, to request additional user authentication when it is determined that a device is different from a previously registered device.

7. The security control system of claim 2,
wherein the user terminal requests the TTP server to perform pre-verification for each verifiable credential (VC) to be included in the VP to generate the VP through an electronic wallet, and
the TTP server performs, in response to the request, pre-verification regarding an issuance structure, expiration period, and revocation for each verifiable credential.

8. A security control system for protecting and authenticating identity information, the security control system comprising a user terminal configured to drive an electronic wallet, a trusted third party (TTP) server, and a backup server,
wherein the user terminal
generates, through the electronic wallet, a private key of a user as a distributed key according to a Schnorr-based FROST (Flexible Round-Optimized Schnorr Threshold signatures) algorithm, and
stores one of a plurality of key shares constituting the generated distributed key in the user terminal and transmits the other key shares to the TTP server and the backup server.

9. An operation method for a security control system for protecting and authenticating identity information, the operation method comprising:
generating, by a user terminal, a private key of a user as a distributed key according to a threshold signature technique through an electronic wallet; and
storing, by the user terminal, one of a plurality of key shares constituting the generated distributed key in the user terminal and transmitting the other key shares to a trusted third party (TTP) server and a backup server.

10. An operation method for a security control system for protecting and authenticating identity information, the operation method comprising:
generating, by a user terminal, a private key of a user as a distributed key according to a threshold signature technique through an electronic wallet;
requesting, by the user terminal, a plurality of key shares constituting the distributed key to be stored in the user terminal, a trusted third party (TTP) server, and a backup server corresponding to respective threshold signature parties in a distributed manner;
generating partial signatures based on key shares held by respective threshold signature parties to perform a threshold signature as user authentication is requested, and combining, by the user terminal, the generated partial signatures to generate an aggregate signature; and
generating, by the user terminal, a verifiable presentation (VP) including the aggregate signature and submitting the generated VP to an authentication request target to request authentication.
